(19) United States
(12) Patent Application Publication
(10) Pub. No.: US 2017/0253368 A1
(43) Pub. Date: Sep. 7, 2017

(54) Thermally-Activated Laminate Construct And Methods Of Using The Same

(71) Applicant: Graphic Packaging International, Inc., Atlanta, GA (US)

(72) Inventors: Weston R. Wilson, Arvada, CO (US); Ryan Portrey, Louisville, CO (US)

(21) Appl. No.: 15/448,797

(22) Filed: Mar. 3, 2017

Related U.S. Application Data
(60) Provisional application No. 62/302,989, filed on Mar. 3, 2016.

(51) Int. Cl. B65D 5/56; B65D 5/42; B65D 5/30; B65D 81/34; B65D 85/00

(52) U.S. Cl. CPC B65D 5/563; B65D 81/3446; B65D 81/343; B65D 85/70; B65D 5/30; B65D 5/4266; B31B 1/26; B31B 1/62; B31B 7/00; B31B 2201/26; B31B 2201/6017; B31B 2201/6095; B31B 2203/066; B31B 2217/0038

(57) ABSTRACT

A construct for holding one or more food products includes a plurality of panels and a film secured to the plurality of panels with an adhesive. The plurality of panels is for at least partially surrounding an interior of the construct and includes a bottom panel and at least one side panel foldably connected to the bottom panel. The film is thermally-activable such that upon exposure to heat, one or more compressive stresses are generated across the film.

### CROSS-REFERENCE TO RELATED APPLICATION

The present application claims the benefit of U.S. Provisional Patent Application No. 62/302,989, filed on Mar. 3, 2016.

### INCORPORATION BY REFERENCE

The disclosure of U.S. Patent Application No. 62/302,989, filed on Mar. 3, 2016, is hereby incorporated by reference for all purposes as if presented herein in its entirety.

### BACKGROUND OF THE DISCLOSURE

The present disclosure generally relates to constructs for holding one or more food products. More specifically, the present disclosure relates to a laminate construct for holding one or more food products and that includes a film that can be thermally-activated to strengthen the construct.

### SUMMARY OF THE DISCLOSURE

According to one aspect of the disclosure, a construct for holding one or more food products comprises a plurality of panels for at least partially surrounding an interior of the construct and a film secured to the plurality of panels with an adhesive. The plurality of panels comprises a bottom panel and at least one side panel foldably connected to the bottom panel. The film is thermally-activable such that upon exposure to heat, one or more compressive stresses are generated across the film.

According to another aspect of the disclosure, a blank for forming a construct for holding one or more food products comprises a plurality of panels for at least partially surrounding an interior of the construct formed from the blank and a film secured to the plurality of panels with an adhesive. The plurality of panels comprises a bottom panel and at least one side panel foldably connected to the bottom panel. The film is thermally-activable such that upon exposure to heat, one or more compressive stresses are generated across the film.

According to another aspect of the disclosure, a method of forming a construct for holding one or more food products comprises obtaining a blank comprising a plurality of panels, applying adhesive to the plurality of panels, securing a thermally-activable film to the plurality of panels with an adhesive, and folding the plurality of panels at least partially around an interior of the construct. The plurality of panels comprises a bottom panel and at least one side panel foldably connected to the bottom panel.

### BRIEF DESCRIPTION OF THE DRAWINGS

Those skilled in the art will appreciate the above stated advantages and other advantages and benefits of various additional embodiments reading the following detailed description of the embodiments with reference to the below-listed drawing figures.

According to common practice, the various features of the drawings discussed below are not necessarily drawn to scale. Dimensions of various features and elements in the drawings may be expanded or reduced to more clearly illustrate the embodiments of the disclosure.

FIG. 1 is a schematic, perspective parts-separated view of a laminate structure according to a first exemplary embodiment of the disclosure.

FIG. 2 is a perspective view of the blank of the laminate structure of FIG. 1 being coated with adhesive.

FIG. 3 is a perspective view of the assembled laminate structure of FIG. 1.

FIG. 4 is a cross-sectional view taken along line 4-4 of FIG. 3.

FIG. 5 is a perspective view of a construct formed from the laminate structure of FIG. 1.

FIG. 6 is an enlarged view of the area of detail identified in FIG. 5.

Corresponding parts are designated by corresponding reference numbers throughout the drawings.

### DETAILED DESCRIPTION OF THE EXEMPLARY EMBODIMENTS

Various aspects of the invention may be understood further by referring to the figures.

For purposes of simplicity, like numerals may be used to describe like features. It will be understood that where a plurality of similar features are depicted, not all of such features necessarily are labeled on each figure. It also will be understood that the various components used to form the constructs may be interchanged. Thus, while only certain combinations are illustrated herein, numerous other combinations and configurations are contemplated hereby.

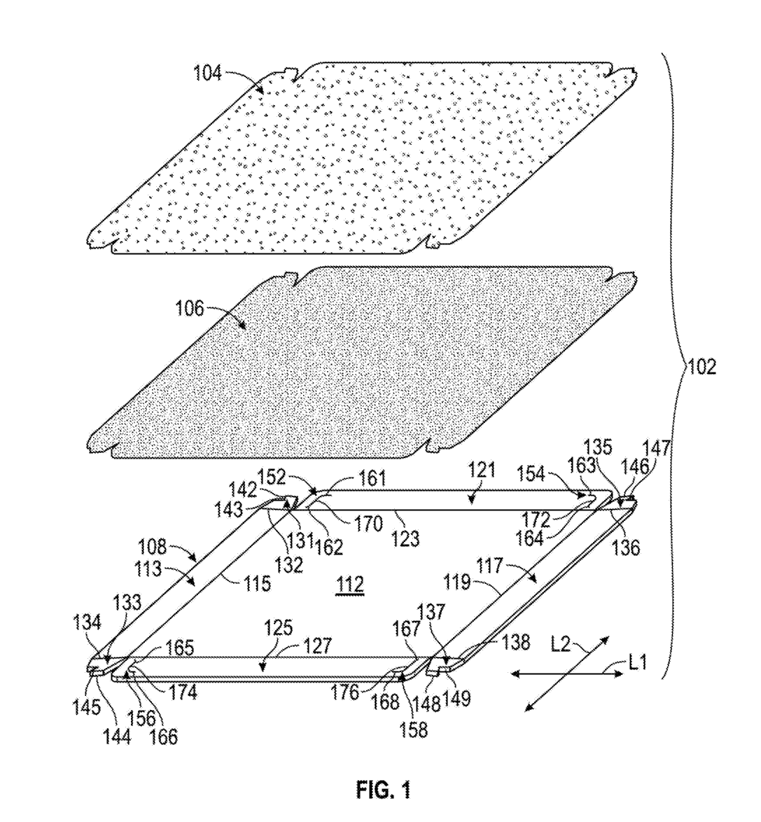

Referring to FIG. 1, a laminate structure 102 for forming a construct 100 (FIG. 5) is illustrated according to a first exemplary embodiment of the disclosure. The construct 100 can be used to hold one or more food products, and can be exposed to heat, e.g., so that the construct 100 can be used in environments having a temperature greater than room temperature, for example, in cooking applications such as baking or microwave cooking. As described herein, the construct 100 can be provided with a film 104 that activates, e.g., reconfigures, upon exposure to heat to provide additional strength to the construct 100. The construct 100 can be a blank, container, carton, or any other suitable construct for holding a food product.

As shown, the laminate structure 102 includes the film 104, an adhesive 106, and the blank 108, which together can be laminated into the construct 100, as described further herein. The interior or food-contacting surface 109 of the blank 108 is illustrated. The blank 108 may be a paper product (e.g., paperboard, cardboard, etc.) and has a longitudinal axis L1 extending along a length of the blank 108, and a lateral axis L2 extending along a width of the blank 108.

As shown, the blank 108 includes a bottom panel 112 foldably connected to a first side panel 113 at a lateral fold line 115, a second side panel 117 foldably connected to the bottom panel 112 at a lateral fold line 119, a third side panel 121 foldably connected to the bottom panel 112 at a longitudinal fold line 123 and a fourth side panel 125 foldably connected to the bottom panel 112 at a longitudinal fold line 127. As shown, the first, second, third, and fourth side panels 113, 117, 121, 125 are positioned to form a perimeter around the bottom panel 112.

In the illustrated embodiment, the first and second side panels 113, 117 have respective first end flaps 131, 133 foldably connected at respective longitudinal fold lines 132, 134, and second end flaps 135, 137 foldably connected at respective longitudinal fold lines 136, 138. In this regard, the third side panel 121 and the end flaps 131, 135 are disposed along a first marginal portion of the blank 108, and the fourth side panel 125 and the end flaps 133, 137 are disposed along a second marginal portion of the blank 108.

As shown, each end flap 131, 133, 135, 137 includes a respective peripheral tab 142, 144, 146, 148 defined by a respective notch 143, 145, 147, 149. The tabs 142, 144, 146, 148 are configured, e.g., sized and/or shaped, to at least partially extend through respective slots 152, 154 and 156, 158 formed in the respective third and fourth side panels 121, 125. Slots 152, 154, 156, 158, as shown, may each include respective opposed curved cuts 161 and 162, 163 and 164, 165 and 166, and 167 and 168 interconnected by respective straight cuts 170, 172, 174, 176. The interengagement of respective tabs 142, 144, 146, 148 and respective slots 152, 154, 156, 158 may facilitate assembly of the construct 100, as described further herein. In embodiments, tabs 152, 154, 156, 158 and slots 142, 144, 146, 148 may have different configurations than those shown and/or alternative features for interengagement may be provided. The blank 108 could have other features or could be alternatively shaped, arranged, and/or configured without departing from the disclosure.

Still referring to FIG. 1, the laminate structure 102 includes the adhesive 106 disposed between the blank 108 and the film 104. The adhesive 106, as described herein, promotes a secure coupling of the film 104 and the blank 108. In the illustrated embodiment, the adhesive 106 is formed of a polymeric material, for example, polyethylene (PE). In other embodiments, a different type of adhesive may be used.

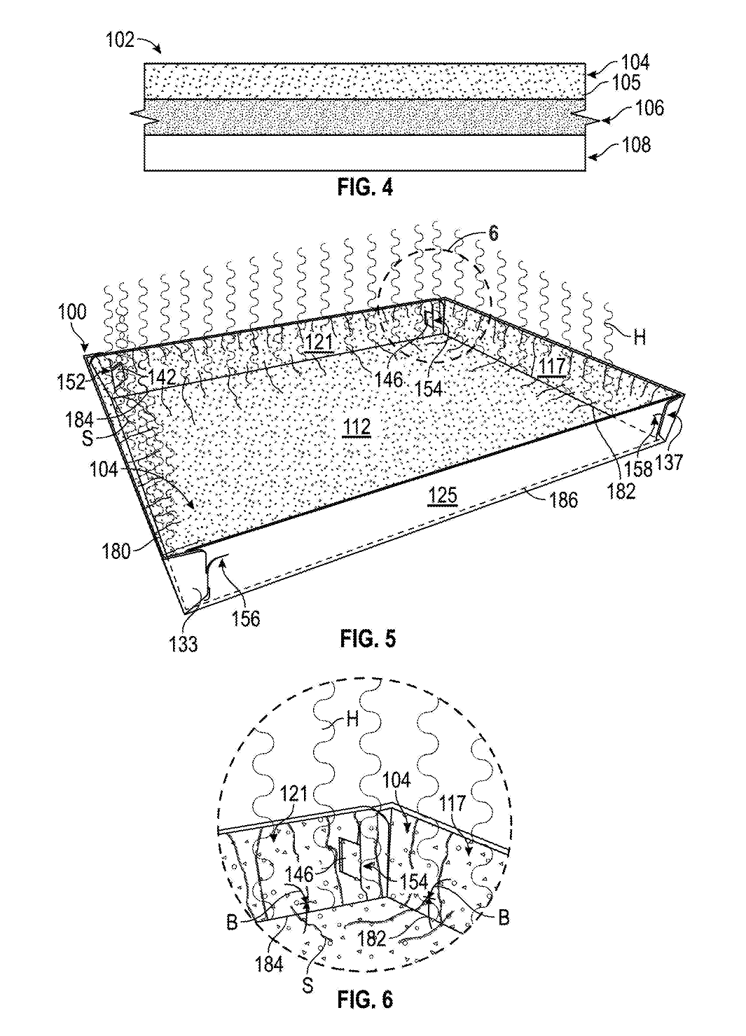

The film 104 of the illustrated embodiment may be formed of a thermally-activated material, for example, a material configured to change at least one material property upon exposure to heat. In this regard, the film 104 may be selected from a heat-shrink material, e.g., a material provided in a first size and reconfigurable to a second, smaller size upon exposure to heat. As described herein, size may refer to one or more of dimensional length, width, height, and thickness such that a change in size may correspond to a change in one or more of surface area, volume, and/or density. The illustrated film 104 may be formed of a polymeric material 105 (FIG. 4), for example, polyethylene terephthalate (PET). In embodiments, the film 104 may be formed of a different material, for example, another polymeric material, and may be provided at an appropriate thickness, for example, 48 Gauge. The film 104 can be any suitable material without departing from the disclosure.

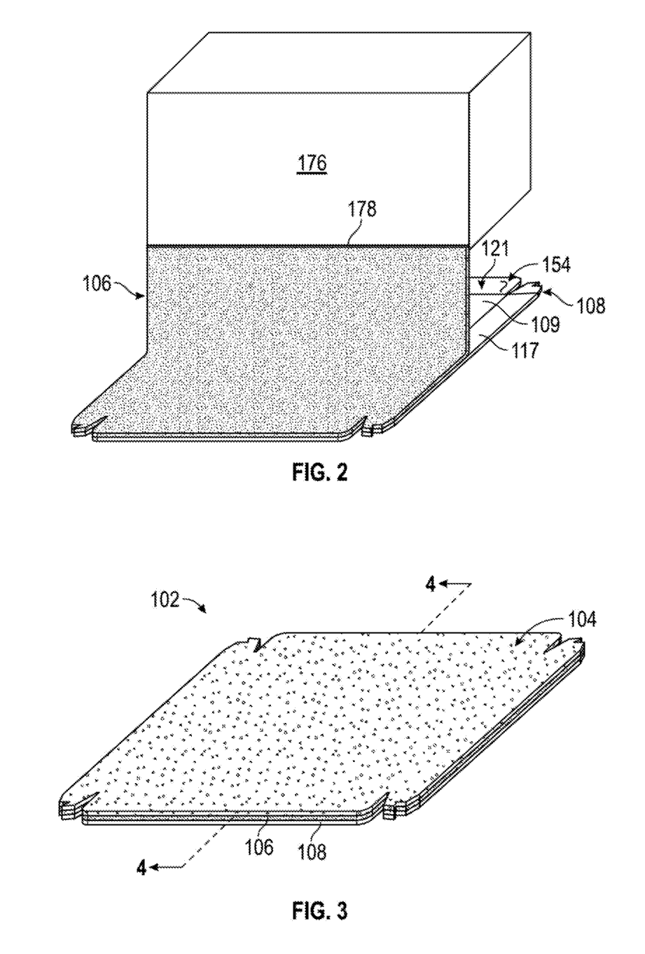

Referring additionally to FIG. 2, in one exemplary embodiment, formation of the construct 100 may include extrusion coating of the adhesive 106 onto the interior surface 109 of the blank 108. Extrusion coating of the blank 108 may be accomplished with an extruder 176 having a slot 178 through which the adhesive 106 can exit such that one or more layers of the adhesive 106 are deposited on the interior surface of the blank 108. As shown, the adhesive 106 may be deposited such that the adhesive 106 covers the entire interior surface 109 of the blank 108. In other embodiments, the adhesive 106 may be deposited on less than the entire interior surface 109 of the blank 108. During deposition of the adhesive 106 on the blank 108, the extruder 176 may movable over the blank 108 as the adhesive exits the slot 178 or the blank 108 may be movable relative to the extruder 176, for example, with a conveyor. In other embodiments, the blank 108 and the extruder 176 may both be positioned for cooperative movement. The adhesive 106 can be applied to the blank 108 by other methods without departing from the disclosure.

With reference to FIGS. 3 and 4, the film 104 is applied to the blank 108 having been coated with the adhesive 106 such that the laminate structure 102 including the blank 108, the adhesive 106, and the film 104 is formed. The film 104, as shown, may be applied in a parallel planar arrangement with the blank 108 following deposition of the adhesive 106 as described herein. In embodiments, the film 104 may be applied in cooperation with deposition of the adhesive 106, for example, through the use of a roller and nip. The film 104 can be applied to the blank 108 in any other suitable manner without departing from the disclosure.

Referring to FIGS. 1, 3, and 5, in one exemplary embodiment, the laminate structure 102 may be formed into the construct 100 by folding the first, second, third and fourth side panels 113, 117, 121, 125 at respective fold lines 115, 119, 123, and 127, and inserting the respective tabs 142, 144, 146, 148 into the respective slots 152, 154, 156, 158. As shown, the formed construct 100 defines an interior 103 with interior edges 180, 182, 184, 186 between the bottom panel 112 and the respective first, second, third, and fourth side panels 113, 117, 121, 125 proximate respective fold lines 115, 119, 123, and 127.

Referring to FIGS. 1, 5, and 6, in use, the construct 100 may be exposed to a heat source

H, for example, a heat source generated by a microwave or convection oven. The film 104 is heat-activable such that upon exposure to heat source H, the film 104 shrinks, e.g., reduces in size, such that one or more stress lines S are generated across the film 104 in response to compressive stresses generated across the film 104. In embodiments, compressive stresses may be generated across the film 104 in response to shrinking without the generation of stress lines S. In the illustrated embodiment, the adhesive 106 is configured to at least partially melt and/or uncure upon exposure to heat source H such that the film 104 is temporarily and partially movable along the interior surface 109 of the blank 108 to facilitate compressive movement of the film 104 across the interior surface 109 of the blank 104. In embodiments, the temporarily melted and/or uncured adhesive 106 may provide an at least partial lubricant to compressive movement of the film 104. However, as described herein, the temporarily melted and/or uncured film 104 may also provide an at least partial resistance to compressive movement of the film 104 such that compressive stresses S are at least partially transferred to the blank 108.

In this regard, the compressive stresses S generated across the film 104 at the interior edges 180, 182, 184, 186 provide a compressive force biasing the bottom panel 112 and the respective first, second, third, and fourth side panels 113, 117, 121, 125 toward one another. In this regard, the compressive stresses S generated upon exposure of the film 104 to the heat source H maintain and promote the upright configuration of the first, second, third, and fourth side panels 113, 117, 121, 125 relative to the bottom panel 112 to inhibit, minimize, and/or prevent unfolding, warping, breaking down, and/or other weakening of the construct 100.

Further, the presence of the film 104 on the construct 100 may provide an at least partial barrier to fluids, e.g., moisture, oxygen, oils, food products, and/or other substances, such that the construct is at least partially fluid-resistant. In this regard, the film 104 provides an at least partial fluid barrier such that the blank 108 can be selected from a material such as clay-coated solid unbleached sulfate (SUS) so that the construct 100 has superior fluid resistance to clay-coated SUS alone. Accordingly, the construct 100 may be provided with a blank 108 formed of a cost-effective material that is afforded additional fluid-resistance via the film 104 such that the construct 100 can compete with other conventional blank materials such as, for example, coated solid bleached sulfate (SBS) board.

While the construct 100 has been illustrated in a tray-like configuration in the exemplary embodiments described herein, in other embodiments, the construct 100 may have a different configuration for example, a container, package, sleeve, tray, plate, bowl, mat, or a hingably-closable enclosure, to name a few.

In general, the blanks described herein may be constructed from paperboard having a caliper so that it is heavier and more rigid than ordinary paper. The blank can also be constructed of other materials, such as cardboard, or any other material having properties suitable for enabling the construct to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the construct embodiments. The term “glue” is intended to encompass all manner of adhesives commonly used to secure panels in place.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

The foregoing description illustrates and describes various embodiments of the disclosure. As various changes could be made in the above construction, it is intended that all matter contained in the above description or shown in the accompanying drawings shall be interpreted as illustrative and not in a limiting sense. Furthermore, various modifications, combinations, and alterations, etc., of the above-described embodiments are within the scope of the disclosure. Additionally, the disclosure shows and describes only selected embodiments, but various other combinations, modifications, and environments are within the scope of the disclosure, commensurate with the above teachings, and/or within the skill or knowledge of the relevant art. Furthermore, certain features and characteristics of each embodiment may be selectively interchanged and applied to other illustrated and non-illustrated embodiments without departing from the scope of the disclosure.

What is claimed is:

1. A construct for holding one or more food products, comprising:
a plurality of panels for at least partially surrounding an interior of the construct, the plurality of panels comprising a bottom panel and at least one side panel foldably connected to the bottom panel; and
a film secured to the plurality of panels with an adhesive, the film being thermally-activable such that upon exposure to heat, one or more compressive stresses are generated across the film.

2. The construct of claim 1, wherein, the compressive stresses generated across the film are at least partially transferred to the plurality of panels.

3. The construct of claim 2, wherein the compressive stresses bias the bottom panel and the at least one side panel toward one another.

4. The construct of claim 3, wherein, upon exposure to heat, the adhesive provides an at least partial lubricant to compressive movement of the film.

5. The construct of claim 1, wherein the film is comprised of polyethylene terephthalate (PET).

6. The construct of claim 5, wherein the adhesive is comprised of polyethylene (PE).

7. The construct of claim 6, wherein the plurality of panels are comprised of clay-coated solid unbleached sulfate (SUS).

8. The construct of claim 1, wherein the adhesive is disposed over an entirety of an interior surface of the respective panels of the plurality of panels.

9. The construct of claim 1, wherein the film is disposed in planar parallel relation with each panel of the plurality of panels.

10. The construct of claim 1, wherein the at least one side panel comprises a first side panel, a second side panel, a third side panel, and a fourth side panel each foldably connected to the bottom panel.

11. The construct of claim 10, wherein the first side panel comprises a first end flap and a second end flap each having a tab, the second side panel comprises a third end flap and a fourth end flap each having a tab, the third side panel comprises a first slot receiving the first tab and a second slot receiving the third tab, and the fourth side panel comprises a third slot receiving the second tab and a fourth slot receiving the fourth tab.

12. A blank for forming a construct for holding one or more food products, comprising:
a plurality of panels for at least partially surrounding an interior of the construct formed from the blank, the plurality of panels comprising a bottom panel and at least one side panel foldably connected to the bottom panel; and
a film secured to the plurality of panels with an adhesive, the film being thermally-activable such that upon exposure to heat, one or more compressive stresses are generated across the film.

13. The blank of claim 12, wherein the compressive stresses generated across the film are at least partially transferred to the plurality of panels.

14. The blank of claim 13, wherein the compressive stresses bias the bottom panel and the at least one side panel toward one another when the construct is formed from the blank.

15. The blank of claim 14, wherein, upon exposure to heat, the adhesive provides an at least partial lubricant to compressive movement of the film.

16. The blank of claim 1, wherein the film is comprised of polyethylene terephthalate (PET).

17. The blank of claim 16, wherein the adhesive is comprised of polyethylene (PE).

18. The blank of claim 17, wherein the plurality of panels are comprised of clay-coated solid unbleached sulfate (SUS).

19. The blank of claim 12, wherein the adhesive is disposed over an entirety of an interior surface of the respective panels of the plurality of panels.

20. The blank of claim 12, wherein the film is disposed in planar parallel relation with each panel of the plurality of panels.

21. The blank of claim 12, wherein the at least one side panel comprises a first side panel, a second side panel, a third side panel, and a fourth side panel each foldably connected to the bottom panel.

22. The blank of claim 21, wherein the first side panel comprises a first end flap and a second end flap each having a tab, the second side panel comprises a third end flap and a fourth end flap each having a tab, the third side panel comprises a first slot for receiving the first tab and a second slot for receiving the third tab when the construct is formed from the blank, and the fourth side panel comprises a third slot for receiving the second tab and a fourth slot for receiving the fourth tab when the construct is formed from the blank.

23. A method of forming a construct for holding one or more food products, comprising:
obtaining a blank comprising a plurality of panels, the plurality of panels comprising a bottom panel and at least one side panel foldably connected to the bottom panel;
applying adhesive to the plurality of panels;
securing a thermally-activable film to the plurality of panels with the adhesive; and
folding the plurality of panels at least partially around an interior of the construct.

24. The method of claim 23, further comprising exposing the film to heat such that one or more compressive stresses are generated across the film.

25. The method of claim 24, wherein, when the film is exposed to heat, the compressive stresses bias the bottom panel and the at least one side panel toward one another.

26. The method of claim 24, wherein, wherein, when the film is exposed to heat, the compressive stresses generated across the film are at least partially transferred to the plurality of panels.

27. The method of claim 24, wherein, upon exposure to heat, the adhesive provides an at least partial lubricant to compressive movement of the film.

28. The method of claim 23, wherein the film is comprised of polyethylene terephthalate (PET).

29. The method of claim 28, wherein the adhesive is comprised of polyethylene (PE).

30. The method of claim 29, wherein the plurality of panels are comprised of clay-coated solid unbleached sulfate (SUS).

31. The method of claim 23, wherein the adhesive is applied over an entirety of an interior surface of the respective panels of the plurality of panels.

32. The method of claim 23, wherein the film is secured in planar parallel relation with each panel of the plurality of panels.

33. The method of claim 23, wherein the at least one side panel comprises a first side panel, a second side panel, a third side panel, and a fourth side panel each foldably connected to the bottom panel.

34. The method of claim 33, wherein the first side panel comprises a first end flap and a second end flap each having a tab, the second side panel comprises a third end flap and a fourth end flap each having a tab, the third side panel comprises a first slot and a second slot, and the fourth side panel comprises a third slot and a fourth slot.

35. The method of claim 34, wherein the folding the plurality of panels comprises inserting the first tab into the first slot, inserting the third tab into the second slot, inserting the second tab into the third slot, and inserting the fourth tab into the fourth slot.
